(19) United States
(12) Patent Application Publication
(10) Pub. No.: US 2024/0276226 A1
(43) Pub. Date: Aug. 15, 2024

(54) METHOD AND APPARATUS FOR DETERMINING A GEOSPATIAL LOCATION OF AN UNLOCATED DEVICE

(71) Applicant: Northeastern University, Boston, MA (US)

(72) Inventors: Pau Closas, Boston, MA (US); Guillermo Wilfredo Hernandez, Boston, MA (US); Gerald Mycko LaMountain, Malden, MA (US)

(21) Appl. No.: 18/395,177

(22) Filed: Dec. 22, 2023

Related U.S. Application Data
(60) Provisional application No. 63/476,843, filed on Dec. 22, 2022.

(51) Int. Cl. H04W 12/63; H04W 12/037

(52) U.S. Cl. CPC H04W 12/63; H04W 12/037

(57) ABSTRACT

Embodiments define a method and apparatus for determining a geospatial location of an unlocated device communicatively coupled to a network while maintaining privacy. The unlocated device transmits a first encryption layer public enabling multiple other devices, including an assistant device, to employ the first encryption layer public key. The assistant device transmits a second encryption layer public key to the multiple other devices, and those devices return to the assistant device respective encrypted representations of geospatial locations encrypted by the first encryption layer public key and the second encryption layer public key. The assistant device decrypts the second layer encrypted representations of the geospatial locations with the second encryption layer secret key; and performs an averaging function on the representations of geospatial locations. The assistant device transmits the encrypted solution to the averaging function to the unlocated device, which decrypts the encrypted solution using the first encryption layer secret key.

### RELATED APPLICATION(S)

This application claims the benefit of U.S. Provisional Application No. 63/476,843, filed on Dec. 22, 2022. The entire teachings of the above application(s) are incorporated herein by reference.

### GOVERNMENT SUPPORT

This invention was made with government support under 1845833 from the National Science Foundation. The government has certain rights in the invention.

### BACKGROUND

Proximity-based positioning is a method of locating a user device's location and may be employed as a simple, yet effective, positioning system in crowded areas in lieu of traditional geospatial locating methods such as Global Navigation Satellite Systems (GNSS) for example, Global Positioning System (GPS). In particular, proximity-based positioning is a range-free solution wherein an unlocated device, such as a receiver, computes its position by knowing where multiple other nearby devices are located. The main requirement, therefore, is that collaborative receivers who know where they are located and are willing to share their position with the unlocated device, that poses a privacy concern as well as a potential limitation in the widespread use of such approach.

### SUMMARY

Disclosed herein is a computer implemented method, and associated apparatus, for determining a geospatial location of an unlocated device communicatively coupled to a network. The method begins by activating a transmission of a first encryption layer public key associated with a first encryption layer, the transmission performed by the unlocated device, or proxy thereof, to enable multiple anonymous other devices communicatively coupled to the network, including an assistant device, to employ the first encryption layer public key. The method then decrypts, at the first encryption layer, by the unlocated device, or proxy thereof, a first layer encrypted anonymized solution to a mathematical function performed and encrypted by the assistant device, or proxy thereof, on representations of the geospatial locations of the multiple anonymous other devices at a first encryption layer, the decrypting performed by using a first encryption layer secret key associated with the first encryption layer public key, the decrypting producing a decrypted solution employed by the unlocated device as a representation of the geospatial location of the unlocated device.

Another embodiment begins by activating a transmission of, by the assistant device, or proxy thereof, a second encryption layer public key to the multiple anonymous other devices in the network in a manner that causes the multiple anonymous other devices to return to the assistant device, or proxy thereof, respective representations of geospatial locations encrypted first by the first encryption layer public key and second by the second encryption layer public key. The method continues by decrypting, at the second encryption layer, by the assistant device, or proxy thereof, the second layer encrypted representations of the geospatial locations of the multiple anonymous other devices a second encryption layer secret key associated with the second encryption layer public key to produce first layer encrypted representations of the geospatial locations of the multiple anonymous other devices. The method then performs a mathematical function on the first layer encrypted representations of the geospatial locations of the multiple anonymous other devices, by the assistant device, or proxy thereof, to produce the first layer encrypted anonymized solution to the mathematical function at the first encryption layer.

Another embodiment includes the unlocated device encrypting a location request message at the first encryption layer, the location request message at the first encryption layer being able to be decrypted by the use of the first encryption layer secret key.

Another embodiment includes the assistant device encrypting a response to the location request message by the multiple anonymous other devices at the second encryption layer, the response to the location request message at the second encryption layer being able to be decrypted by the use of a second encryption layer secret key.

Another embodiment includes the unlocated device encrypting at the first encryption layer or, by the assistant device, at the second encryption layer a location request message, or a response to a location request message by the multiple anonymous other devices at the second encryption layer using an encryption method that has an ability to perform an unlimited number of addition and multiplication operations on a ciphertext.

Another embodiment includes: (i) encrypting a location request message to ciphertext using the first encryption layer public key, the second encryption layer public key, or a combination thereof, and (ii) decrypting the ciphertext using the first encryption layer secret key, the second encryption layer secret key, or a combination thereof.

Another embodiment includes performing, by the assistant device, an averaging function of anonymized responses to a location request message received by the multiple anonymous other devices. The embodiment continues by the unlocated device decrypting a response to a location request message containing the encrypted anonymized solution to the mathematical function, the solution being the average of the representations of the geospatial locations of the multiple anonymous other devices.

Another embodiment includes selecting the multiple anonymous other devices from a plurality of devices based on an indication of a distance from the unlocated device, the indication being a function of a response time to a broadcast signal initiated by the unlocated device, the assistant device, or a combination thereof.

Another embodiment includes enabling the multiple anonymous other devices to provide, representations of respective geospatial locations at the first encryption layer by using a first encryption layer public key, and at a second encryption layer by using the second encryption layer public key. The embodiment continues by causing at least one of the multiple anonymous other devices in a fixed location to provide a representation of a geospatial location.

Another embodiment includes the network having a perimeter defined by perimeter devices of the multiple other devices defining a network boundary, and further including analyzing multiple consecutive decrypted anonymized solutions to the mathematical function to determine that the unlocated device is within the perimeter of the network boundary.

Another embodiment includes the unlocated device choosing at least one assistant device from the multiple devices. The embodiment continues by determining, amongst the candidate assistant devices, which of the multiple anonymous other devices may serve as the assistant device.

Another embodiment includes at least one assistant device performing the averaging of the respective representations of geospatial locations of the multiple anonymous other devices.

Another embodiment includes the use of the first encryption layer and second encryption layer, and sequence of use thereof, preserving private information, identity, and geospatial location of the multiple anonymous other devices in the network.

Another embodiment includes the network being a non-satellite based geospatial location network, and the unlocated device self-identifying a loss of, or an uncertainty of, satellite-based geospatial location information, and activating a secondary non-satellite based geolocating method, the secondary geolocating method performs the transmitting and the decrypting to determine the geospatial location of the unlocated device.

Another embodiment includes estimating, by each of the multiple anonymous other devices, a respective position value accuracy by using any one of an optimal estimator, an unweighted optimal estimator, or an unweighted proximity-based estimator.

Another embodiment includes transmitting the first encryption layer public key to a repository or server, the multiple anonymous other devices being communicatively coupled to the repository or server, and the multiple anonymous other devices transmit their representations of geospatial location to the repository or server to be retrieved by the unlocated device.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a representation of a scene where a user's device experiences a loss of geospatial location information, and the device transmits a location request message to multiple other devices in the network, including an assistant device, to collectively return an average of their respective geospatial locations to the user's device.

FIG. 1B is a representation of a scene depicting the data transfer between the unlocated device, an assistant device, and multiple anonymous other devices.

FIG. 1C is a representation of a scene depicting the data transfer between the unlocated device, a server or repository, and multiple anonymous other devices.

FIGS. 2A-2C are a network flow diagram of how information may be passed between the unlocated (user) device, the assistant device, and the multiple anonymous other devices on the network.

FIG. 3 is a diagram that illustrates a proximity-based positioning method in an exemplary network.

FIG. 4 is a flow of encrypted cyphertext as it passes through the first encryption layer and the second encryption layer.

FIG. 5 is an illustration of how the public keys and secret keys are created and distributed throughout the network.

FIG. 6 is a plot illustrating the relationship between the number of users versus the RMSE value.

FIG. 7 is a plot illustrating the relationship between the number of users versus time using the polynomial degree 2048.

### DETAILED DESCRIPTION

A description of example embodiments follows.

Proximity-based location is a computer implemented method (method) of geospatial location that can be used to inform a user of the approximate location of the user's device by knowing where multiple other devices on a network are located. Embodiments described herein utilize multiple layers of encryption, as well as both public and private (also referred to herein as secret) encryption keys, to create a secure communication between the unlocated device, an assistant device, and a plurality of multiple other devices. This way, the identity of both the unlocated device, as well as the multiple other devices on the network, maintain anonymity throughout the process.

In an example embodiment, encrypted positions are shared among the collaborative agents in order to implement a proximity-based solution that does not reveal the identity or position of neighboring nodes. With the use of homomorphic encryption, a framework is established that performs operations to obtain position estimates, while the information of any participating user or device remains private. Example embodiments provides equivalent performance to the case where no privacy-security guarantees are provided.

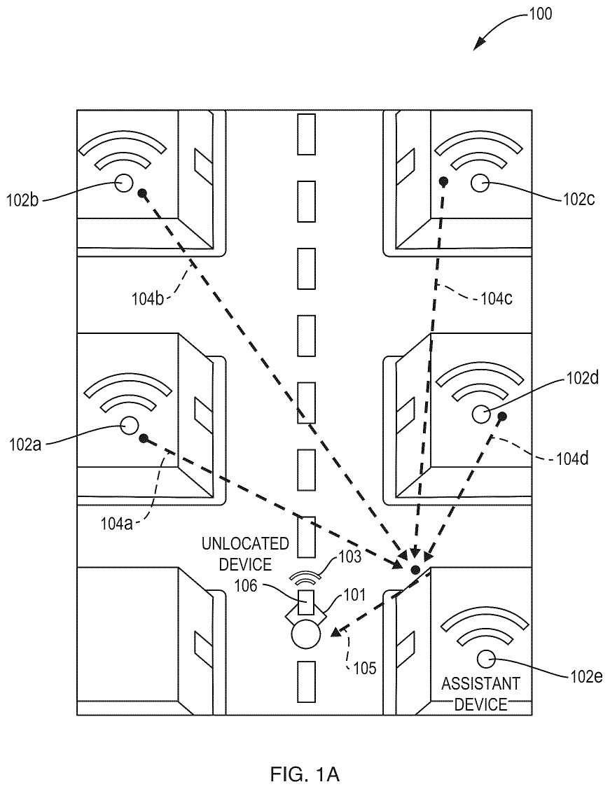

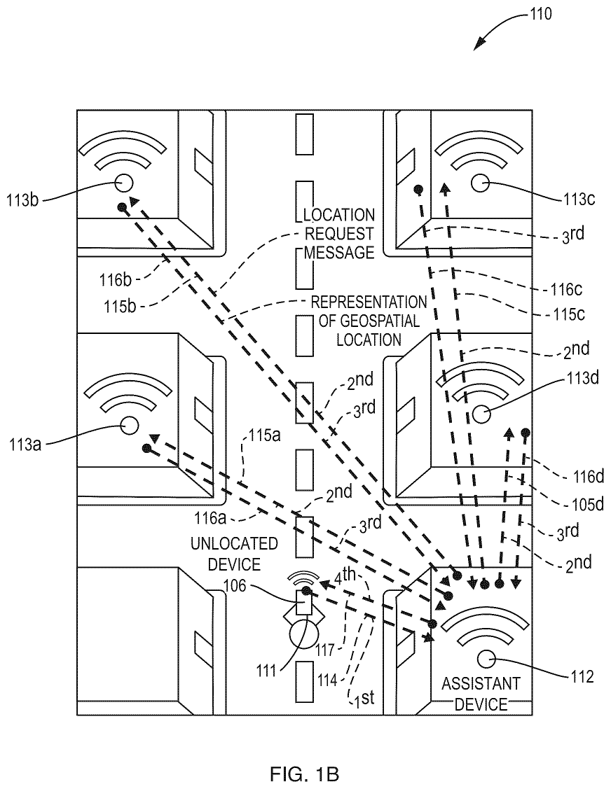

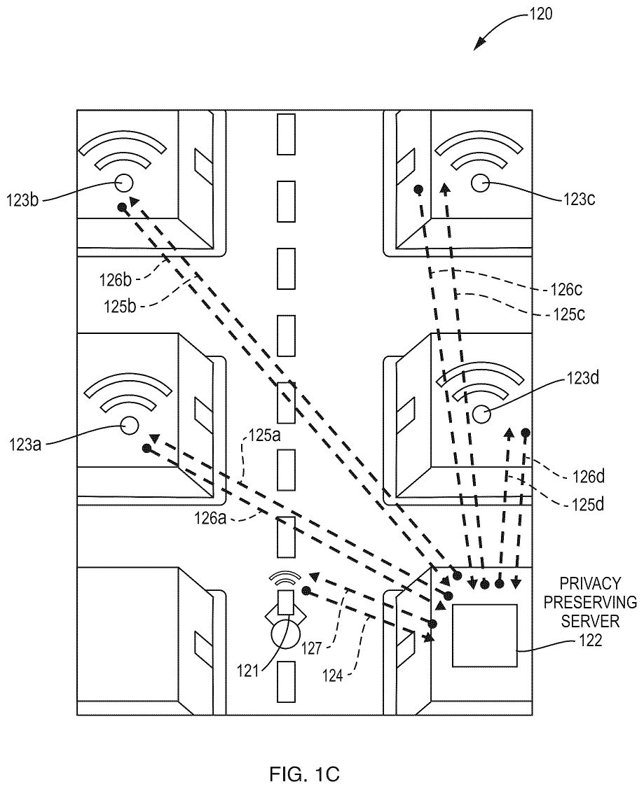

FIG. 1A is a representation of a scene 100 showing a user with an unlocated user 101 device 106 traveling throughout an environment that is void of Global Navigation Satellite Systems (GNSS), for example, Global Positioning System (GPS), according to an embodiment. The user's 101 unlocated device 106, for example, a cellular phone, may identify its own loss of location information, and may activate the transmission of a location request message 103 to multiple other devices on the network 102a-e, including an assistant device 102e, or proxy thereof. These other devices may be, but are not limited to, cellular phones, servers, laptops, and similar devices that know their geospatial location.

The assistant device 102e, which may be selected randomly from the multiple other devices, or may be selected by the multiple other devices, is responsible for sending the first layer and second layer public encryption keys to the multiple other anonymous devices. The assistant device also receives the representations of geospatial locations from the multiple anonymous other devices, performs a mathematical calculation with the representations of geospatial locations, and sends the encrypted solution to the mathematical calculation to the unlocated device.

In addition, these other devices 102a-e may be in a fixed location, such as defining the perimeter of a network, or may be constantly mobile, such as a collection of mobile devices. Through multiple layers of encryption, described below, the multiple other devices 102a-e on the network transmits an encrypted message 104a-d containing respective representations of their geospatial location to the assistant device 102e on the network.

In an example embodiment, the assistant device 102e then performs an averaging function on the representations of geospatial locations provided by the multiple anonymous other devices 102a-e on the network. The assistant device 102e provides, via an encrypted message 105, an average (or other result of a mathematical calculation, look-up table retrieval, or the like) of the locations received from the multiple anonymous other devices 102a-e on the network to the user's unlocated device 101. Therefore, the user's device 101 may receive an approximate location of its own location by knowing that it is in the same approximate location as the received average location of the multiple anonymous other devices, without knowing the identity or the location of any of these other devices. This way, privacy is preserved throughout the process.

FIG. 1B is a representation of a scene 110 illustrating the data transfer between the unlocated device 111, the assistant device 112, and the multiple anonymous other devices 113a-d, according to an embodiment. The unlocated device sends a location request message to the multiple anonymous other devices on the network, and once an assistant device 112 is determined, which may be by random or may be determined by the multiple anonymous other devices on the network, the unlocated device 111 transmits a first encryption layer public key 114 along with the location request message to the assistant device 112. The assistant device 112 transmits the first encryption layer public key and a second encryption layer public key 115a-d, along with the location request message, to the multiple anonymous other devices 113a-d on the network. The multiple anonymous other devices 113a-d on the network sends encrypted representations of their respective geospatial locations 116a-d to the assistant device 112. The assistant device 112 performs an averaging function on these representations of geospatial locations, and then transmits the encrypted solution to the mathematical averaging function 117 to the unlocated device 111.

FIG. 1C is a representation of a scene 120 illustrating a data transfer between the unlocated device 121, a server or repository 122, and the multiple anonymous other devices 123a-d, according to an embodiment. The unlocated device sends a location request message, along with a first encryption layer public key 124 to a server or repository 122. The server or repository 122 transmits the first encryption layer public key and a second encryption layer public key 125a-d, along with the location request message, to the multiple anonymous other devices 123a-d on the network. The multiple anonymous other devices 123a-d on the network sends representations of their respective geospatial locations 126a-d to the server or repository 122. The server or repository 122 performs an averaging function on these representations of geospatial locations, and then transmit the encrypted solution to the mathematical averaging function 127 to the unlocated device 121.

In an embodiment, the transmission of the location request message may be transmitted to a repository or server, wherein the multiple anonymous other devices are communicatively coupled to the repository or server, and the multiple anonymous other devices transmit their representations of geospatial location to the repository or server to be retrieved by the unlocated device.

In another embodiment, the network is a non-satellite based geospatial location network, and wherein the unlocated device self-identifies a loss of, or an uncertainty of, satellite-based geospatial location information, and activates a secondary non-satellite based geolocating method, the secondary geolocating method performs the transmitting and the decrypting to determine the geospatial location of the unlocated device.

Both outdoor and indoor location and positioning research and technology has increased over the recent decades. For outdoor tracking, research and technology depend on satellite technologies, for example, Global Navigation Satellite System (GNSS) such as, Global Positioning System (GPS) [16]. With an indoor environment, these resources become limited due to physical infrastructures, or other obstacles, that may lead to signal obstructions or distortion. Addressing the concern of limited GNSS resources for indoor environments has driven researchers to explore methods in order to improve the accuracy of estimating location and position values [2]. Studies presented, and not limited to, in [4], [5], [14], have evaluated different approaches for indoor estimated location and positioning, one of which is the proximity-based service (PBS) method.

It is common to use resources like WiFi for proximity-based service (PBS), to be used as alternatives within an indoor setting, as in the case of fingerprint-based indoor position algorithms, described in [11]. Other resources like Bluetooth Low Energy (BLE) devices with PBS capabilities can also provide a desired outcome, [7], [27]. Yet, there are other approaches that combine both resources to be able to obtain the common goal, as seen in [24]. Additionally, it is also common to encounter methods that utilize collaborating users in order to increase the accuracy of these estimated values [23]. An emergence of applications has equally surfaced with these new solutions. As of recently, the urgency of the social-distance measure due to the global pandemic caused by COVID-19 has led to the usage of the PBS, and additionally the increased technology infuses to smart environments [3], [8], [20].

The proximity-based service (PBS) process requires the necessary step of identifying target devices that may partake in the network of devices. With the resources, such as Bluetooth Low Energy (BLE) devices or WiFi, the service is able to identify such target devices who may fall within the category to engage in such a network in order to optimize the network localization accuracy. In [26], Yin el at. described a general framework to establish a threshold for the received-signal-strength (RSS) in order to create such optimal network. As an alternative, other methods include integrating a weighted K-Nearest Neighbor algorithm [19].

Another part of the proximity-based service is the ability to produce accurate estimating position and location values. Just like the initial portion of the service, this area of research has grown and gained much attention. In [21], Subedi el al. described using a weighted centroid with affinity propagation clustering to obtain higher accurate estimated values. Bayesian approaches using the Kalman filter, the particle filter, and the non-parametric information filter have also been implemented to remove any noise in the estimated values [15], [25].

These approaches may provide an estimate for position, velocity, and time (PVT) values, that are desired for indoor positioning environments, however these methods lack privacy. The privacy concern is introduced when the sensitive data from collaborative users is used during the computation process when determining the estimated PVT values. An approach that takes into consideration this privacy concern is the k-nearest neighbor (KNN) classification method. The KNN classification method adds a privacy layer by adding noise to the sensitive data used to calculate the PVT estimate values. Based on Chebyshev's inequality, however, this approach would require more resources to validate the estimated values. Thus, more users are required to reduce the variance of the estimated values. Accurate estimation results under these conditions may be infeasible if not enough users are within the service's range of operation.

Another approach to preserve privacy, is the use of encryption. A Fully Homomorphic Encryption (FHE) has gained much research attention, and it was explored in [12] to preserve the privacy between users to obtain PVT estimated values within a cooperative positioning method.

Embodiments described herein introduce a two-stage solution that preserves the privacy for a network of users in the proximity-based service. Since the privacy concern exists in the computational process of estimating the position of a user, it will be referred to as the proximity-based positioning method. This approach considers all users to be mutually adversarial, or untrustworthy, and it eliminates the need for a trustworthy party that has full access to any sensitive data provided by the network of users. Additionally, this solution takes into account that the network's users are capable of communicating with one another without any issue.

Several works have explored methods of allowing nearby neighbors to exchange their own position in a private manner. One such approach is the k-anonymity method, that obscures the untrusted server rendering it unable to distinguish the true position of a user and k−1 other arbitrary positions. The level of privacy under such approach is proportional to the number of users within the network. As the number of k users increases, the privacy level increases. The concept of proximity-based positioning has also been explored in the encryption community. Novak el at. described a protocol for identifying a device that is within an indicated distance [18]. Under this protocol, any two users should be willing to share their position with one another once they are within a certain proximity of each other. Both users encrypt their position in such a way that it can be determined if their relative positions are within an indicated subset boundary. If this is determined to be true, the user Bob would send user Alice an n polynomial which Alice must evaluate and send the results back to Bob. Once Bob obtains a result that met the proximity criteria, Bob would send Alice his position.

Additionally, Narayanan et al. described using ElGamal encryption in [17] to securely determine the position of a user. The solution enables the users to adjust the proximity area in that they operate and indicates whether or not they are willing to share their position within this area. Additionally, it depends on a social network or graph to establish relationship with people. It uses this information, amongst other technology resources like location tags during the matching process.

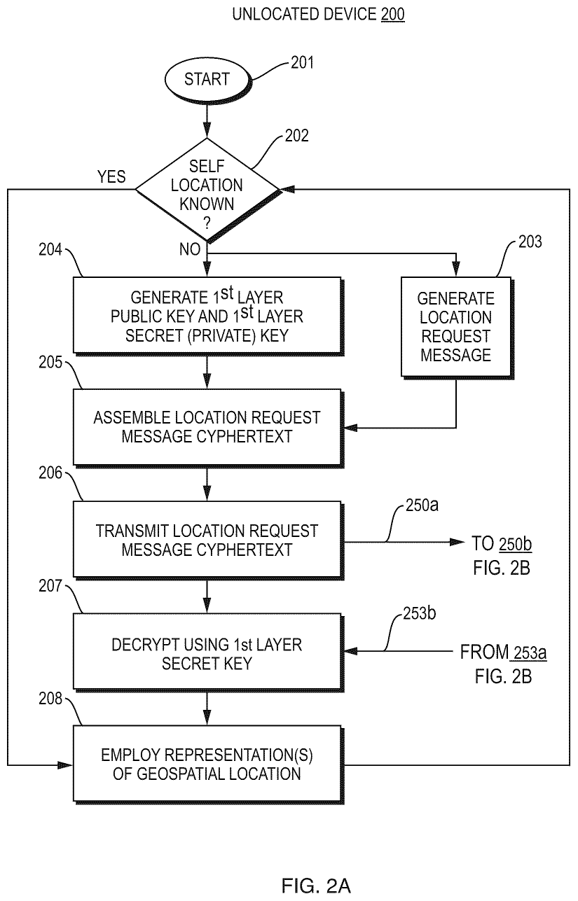

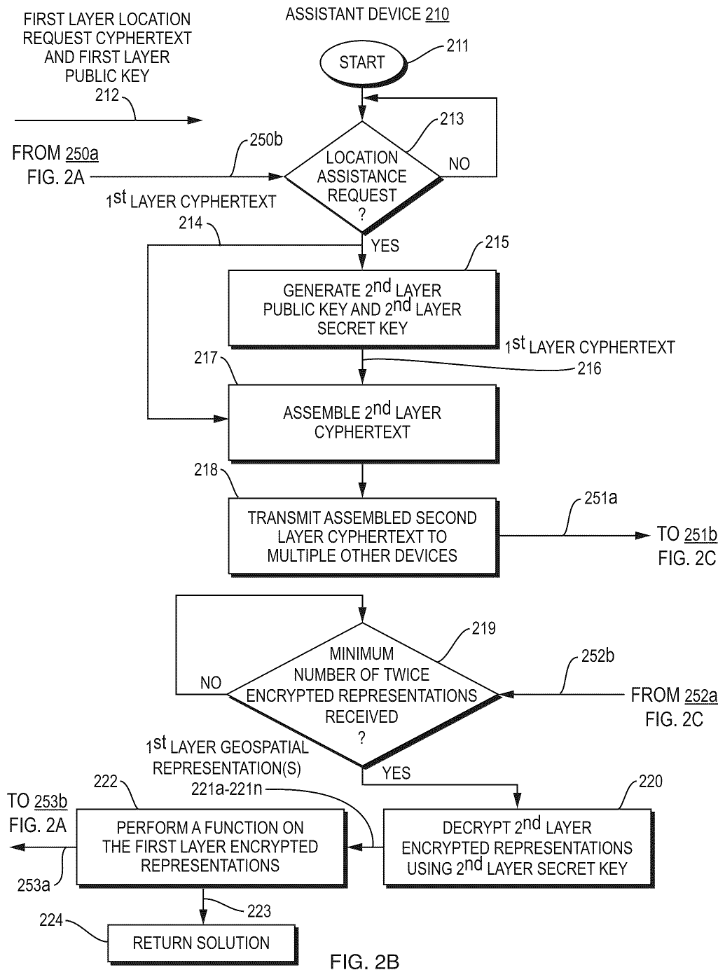

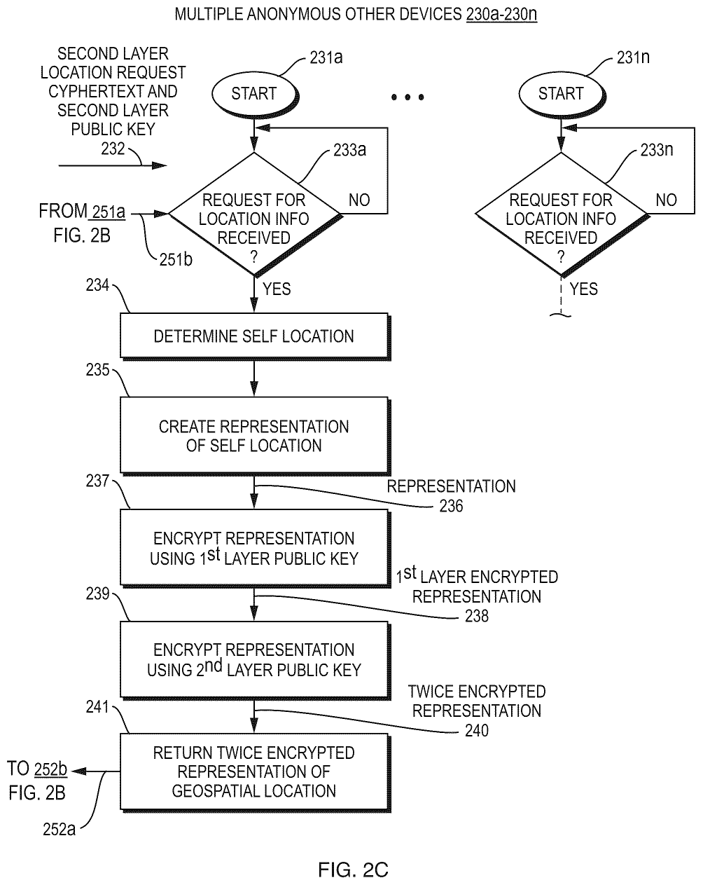

FIG. 2A-2C shows a network flow diagram of how information may be passed between the unlocated (user) device 200, the assistant device 210, and the multiple anonymous other devices 230 on the network, according to an embodiment. At FIG. 2A the unlocated device 200 begins at “start” 201 which may be, for example, when the unlocated device 200 no longer knows its geospatial location, and then performs an inquiry 202 regarding if it knows its own geospatial location. If the answer to the inquiry 202 is “yes,” then the device employs its representation of geospatial location 208, then moves to depiction A and starts the process over at 202. If the answer to the inquiry 202 is “no,” then the unlocated device 200 generates 204 a first encryption layer public key and a corresponding first encryption layer secret (private) key as well as generating 203 a location request message. The unlocated device 200 will assemble 205 the first encryption layer public key, and the location request message into a cyphertext. Next, the unlocated device 200 will transmit 206 the first encryption layer location request cyphertext and the first layer public key 212 to an assistant device 210 over a wireless communication path 250a-b.

At FIG. 2B, the assistant device 210 starts at 211 and performs an inquiry 213 as to if it has received a request for location assistance. If the answer to the inquiry 213 is “no,” then the device repeats the inquiry 213. If the answer to the inquiry 213 is “yes,” then the assistant device 210 utilizes the first layer cyphertext 214 and generates 215 a second layer public key and a corresponding second layer secret key. Next, the assistant device 210 takes the first layer cyphertext 216 and assembles 217 the second layer cyphertext with the second encryption layer public key. The assistant device 210 will transmit 218 the assembled second layer location request cyphertext and the second layer public key 232 along with the first layer public key to the multiple anonymous other devices 230a-n over a wireless communication path 251a-b.

At FIG. 2C, the multiple anonymous other devices 230a-n start at 231a-n and perform an inquiry 233a-n as to whether a request for location information has been received. If the answer to the inquiry 233a-n is “no,” then the multiple anonymous other devices 230a-n repeat the inquiry 233a-n. Additional multiple other devices may be present, however only one is shown for clarity. If the answer to the inquiry 233a-n is “yes,” then the multiple anonymous other devices 230a-n determine 234 their self-location and create 235 a representation 236 of their respective geospatial location. The representation 236 is then encrypted 237 using the first encryption layer public key, creating a first layer encrypted geospatial location representation 238. The first layer encrypted geospatial location representation 238 is then further encrypted 239 using the second encryption layer public key, creating a twice encrypted representation 240 of their respective geospatial locations. The multiple anonymous other devices 230a-n will then return 241 the twice encrypted representation 240 to the assistant device 210 over a wireless communication path 252a-b.

Returning to FIG. 2B, once the twice encrypted representation 240 is received at the assistant device 210, the assistant device 210 will perform an inquiry 219 as to whether the minimum number of twice encrypted representations have been received. The minimum number of twice encrypted representations could be as low as one, and upwards of as many as the system dictates. If the answer to the inquiry 219 is “no,” the assistant device 210 will repeat the inquiry 219. If the answer to the inquiry 219 is “yes,” the assistant device 210 will decrypt 220 the second layer encrypted representations using the second layer secret key. The assistant device 210 will then take the now second layer decrypted, first layer encrypted, representation(s) 221a-n and perform 222 a function (e.g. a mathematical averaging function) on the aggregate of the first layer encrypted representation(s) 221a-n, producing a solution to the mathematical averaging function 223. The assistant device 210 will then return 224 the solution to the unlocated device 200 over a wireless communication path 523a-b.

Returning to FIG. 2A, the unlocated device 200 will receive the solution to the mathematical averaging function and perform a decryption 207 using the first encryption layer secret key. The unlocated device 200 will then employ 208 the representation(s) of geospatial location, to gain knowledge about its own geospatial location. The method then follows to depiction A and returns to the inquiry 202 and repeats the method if necessary.

### Proximity-Based Positioning

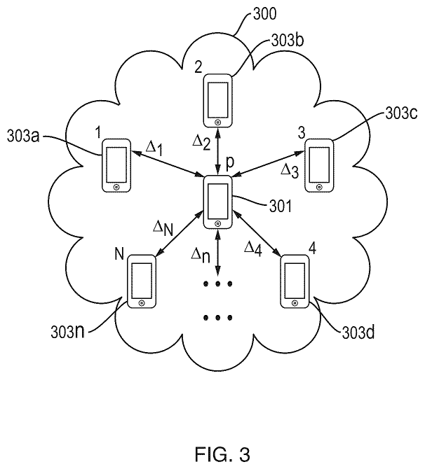

FIG. 3 illustrates a proximity-based positioning method in an example network 300, according to an embodiment. The proximity-based positioning method consists of multiple neighboring users 303a-n sharing their positions with the unlocated user device 301, also referred to herein as the p-th user, unlocated device, or user device, with the objective of enabling the p-th user 301 to estimate its position.

Described herein is the mathematical model used in a proximity-based positioning method, as well as the main assumptions required for the estimators in this positioning solution. The mismatch between the assumed models and the actual configurations of the network lead to the use of biased estimators, described herein. Consider a proximity-based positioning method that is composed of N>2 neighboring users, who act as mobile devices. This network of users also knows their own position coordinates, mₙ, and it is known only to themselves, as illustrated in FIG. 3. There also exist a p-th user (the user device, or the unlocated device) who does not know its position coordinates, mₚ. The objective of the network is to provide the p-th user with a position estimate. All N users are positioned relativity near to the p-th user, and the distance between it and an n-th user is Δₙ. This is modeled as:

$${m}_{n} ≃ {m}_{p} + {Δ}_{n} 0 < ‖ {Δ}_{n} ‖ < ϵ n = 1 , … , N \qquad ( 1 )$$

Assuming that all N users satisfy the condition that the distance between them and the p-th user is less than the boundary condition given by c, then it becomes possible to obtain an estimate of the p-th user's position. However, the n-th user may not guarantee that mₙ is its true position value due to an existing level of uncertainty. The transmitted position equation (1) is modeled as:

$${y}_{n} = {m}_{n} + {w}_{n} n = 1 , … , N \qquad ( 2 )$$

Where wₙ is a random term that accounts for measurement uncertainty, and this uncertainty is independent of the uncertainty associated with any other user. wₙ has a Gaussian distribution with zero-mean and finite variance:

$${w}_{n} ∼ ( 0 , {σ}_{{w}_{n}}^{2} I ) \qquad ( 3 )$$

Again, the network's objective is to estimate the position of the p-th user using the N users observed measurements, also seen as the transmitted position in equation (2). From all the observed measurements, it becomes possible to construct the likelihood function given the true position of the p-th user, i.e.:

$$p ( {y}_{1} , {y}_{2} , … , {y}_{N} \vert {m}_{p} )$$

The p-th user can find its position value by maximizing the likelihood function above; this value becomes the estimated position for the p-th user, i.e.:

$${\hat{m}}_{p} = {arg max}_{{m}_{p}} p ( {y}_{1} , {y}_{2} , … , {y}_{N} \vert {m}_{p} ) \qquad ( 4 )$$

The estimated position values' accuracy depends on the amount of assumptions made during the process of maximizing the likelihood function, thus leading to the different possible estimators for the proximity-based positioning method. Across all the estimators, it is assumed that the uncertainty in the measurements seen in the observed data have the same distribution and they are independent from one another, therefore the observed data values have an iid.

First, consider the case where each n-th user knows the variance of its measurement uncertainty and this uncertainty is not the same for all N users, (i.e., σ²_{wn}≠σ²_{wn′} for n≠n′). Additionally, there exists a distance between the n-th user and the p-th user (i.e., Δₙ≠0). This is considered the optimal estimator and is given by:

$${\hat{m}}_{p} = \frac{{\sum }_{n = 1}^{N} ( {y}_{n} - {Δ}_{n} ) ( {σ}_{{w}_{n}}^{- 2} I )}{{\sum }_{n = 1}^{N} ( {σ}_{{w}_{n}}^{- 2} I )} \qquad ( 5 )$$

It is not always possible that a user may know the variance of its measurement uncertainty, therefore this may change the estimator above. This leads to the next estimator.

The unweighted optimal estimator considers that each measurement uncertainty variance for the observed data is the same for all the data received, meaning that σ²_{wn}=σ²_{wn′} for n≠n′, but it still considers that each n-th user's position is some distance away from the p-th user and is given by:

$${\hat{m}}_{p} = \frac{1}{N} {\sum }_{n = 1}^{N} ( {y}_{n} - {Δ}_{n} ) \qquad ( 6 )$$

Similar to the optimal estimator (5), the unweighted optimal estimator equation (6) assumes that each n-th ser knows the p-th user's position, since it knows the distance from the p-th user. This also considers hat the Δₙ≠0 for all N users. The last estimator is the unweighted proximity-based estimator. It has the same assumptions as the unweighted optimal estimated in equation (6) and it extends on the assumption that as the distance between the n-th and p-th users approaches zero and the n-th user's position converges to the p-th user's position, i.e., mₙ≃mₚ as Δn→0. The estimator is given by:

$${\hat{m}}_{p} = \frac{1}{N} {\sum }_{n = 1}^{N} {y}_{n} \qquad ( 7 )$$

$$E [ {\hat{m}}_{p} ] = \frac{1}{N} {\sum }_{n = 1}^{N} E [ {y}_{n} ] {=}^{{Δ}_{n} \to 0} \frac{1}{N} {\sum }_{n = 1}^{N} {m}_{p} = {m}_{p} \qquad ( 8 )$$

It is noted that the unweighted proximity-based estimator is considered to be an unbiased estimator, as shown in equation (8).

The unweighted proximity-based estimator may be considered later for the encrypted proximity-based positioning method.

### Homomorphic Encryption

Disclosed herein is a method to provide a privacy-preserving method for proximity-based positioning, that necessitates sharing of position information among the network of users. Research on the topic of Fully Homomorphic Encryption (FHE) has rapidly increased since the first solution was introduced by Gentry [9], [10], [22]. The significance of FHE is due to its ability to perform unlimited number of addition and multiplication operations on ciphertexts, a capability that was not possible before [1].

Since its first described solution, many have used the Gentry blueprint to develop newer FHE methods based on the computation security of the Learning with Errors (LWE) problem and the ring-LWE (RLWE) problem. FHE methods come with a high computationally expense and this has led to different attempts to minimize this issue, such as in [6], [10].

A FHE method requires three main components: a key generating algorithm KeyGen(⋅), an encryption algorithm Enc(⋅), and a decryption algorithm Dec(⋅). The SecretKeyGen and PublicKeyGen algorithms, that fall under the key generating algorithm KeyGen(⋅), are responsible for creating a pair of private and public keys, respectively. The public key is used to encrypt a plaintext message into a ciphertext, and the private key is used to decrypt a ciphertext into a plaintext message. If a primary user wishes to communicate with a secondary user, the primary user generates a set of public and private keys. The public key is distributed to the secondary user. This secondary user may then use the public key to encrypt its message before sending it to the primary user. The primary user then receives the encrypted message (in ciphertext form) and uses its private key for the decryption process. After the decryption process, the primary user obtains the secondary user's message. The private key always remains with the primary user, and it is never distributed to any other user.

Cryptographic homomorphism refers to encryption methods that allow certain operations to be performed on encrypted data. A fully homomorphic encryption (FHE) system is one that supports performing an unlimited number of addition and multiplication operations on encrypted data without corrupting the value obtained when the result is decrypted. This means that if the encryption and decryption functions are denoted as Enc(⋅) and Dec(⋅), and the operator is represented by ƒ(⋅, ⋅), then for two messages m₁ and m₂:

$$Dec ( f ( Enc ( {m}_{1} ) \text{?} Enc ( {m}_{2} ) ) ) = f ( {m}_{1} , {m}_{2} ) \qquad ( 9 )$$

$$\text{?} \text{indicates text missing or illegible when filed}$$

This allows for multi-step computations to be performed on encrypted data and it produces the same result as if the data were not encrypted. Since FHE also allows for an unlimited number of operations to be performed on encrypted data, it is usable in the deployment of more complex algorithms and applications.

The FHE systems are considered to be secure based on the computational security of the Learning With Errors (LWE) problem, or its variant, the ring-Learning With Errors (RLWE) problem. The security of the system is determined by the security parameter, that are commonly 128-bit, 192-bit, or 256-bit. For a FHE system based on the RLWE problem, such as the FV method in [6], messages are converted into plaintexts, that are then encrypted into ciphertexts. The plaintext space is taken from a polynomial modulus quotient ring Rₜ with polynomial degree n and coefficients with modulus t. Similarly, the ciphertext is a polynomial in R_{q} with modulus value q. Based on [6], the polynomial degree, n, must be a power of 2. A larger n value leads to a larger polynomial size, and it increases the computation resources. Additionally, with a large polynomial degree, there is an increase in the ciphertext and plaintext modulus values, q and t, respectively.

### Encrypted Proximity-Based Positioning Network

### Overview

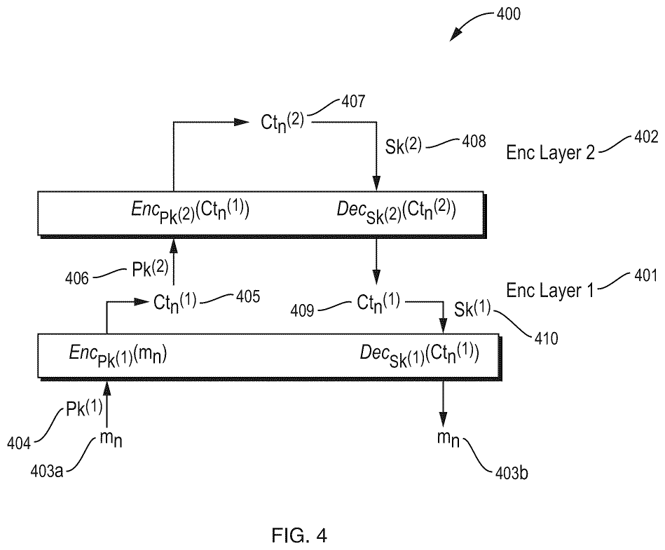

FIG. 4 illustrates a simplified flow 400 of encrypted cyphertext as it passes through the first encryption layer 401 and the second encryption layer 402. The message 403a, mₙ, is encrypted twice in order to preserve it privacy. 403 mₙ is first encrypted using the first public key 404, Pk⁽¹⁾, then its ciphertext 405 within the first layer of encryption 401, Ct⁽¹⁾ 405 is encrypted using the second public key 406, Pk⁽²⁾. This is the ciphertext 407 within the second layer of encryption 402, Ct⁽²⁾. To decrypt the message, a similar process is performed. The second private key 408, Sk⁽²⁾, decrypts Ct⁽²⁾ 407 to obtain a ciphertext within the first layer of encryption, Ctₙ⁽¹⁾ 409 and Sk⁽¹⁾ 410 used to decrypt Ctₙ⁽¹⁾ to reveal the message 403b mₙ.

The privacy-preserving proximity-based positioning method uses two layers of encryption to maintain the privacy for all the users within the network. FIG. 2 illustrates the establishment of these encryption layers, the necessary inputs and outputs of each layer, and the public and private keys needed to access these layers.

A layer of encryption is created with a set of public and private keys. The case of a two layer of encryption, it requires two sets of public and private keys. A single layer of encryption would not be appropriate for the privacy-preserving proximity-based positioning method. This would introduce the possible risk that the user who created the first layer has access to the set of public and private keys. This indicates that this user has access to all the encrypted data, in this case the positions of all the users, and it is able to decrypt all their encrypted messages. However, by having two layers, this approach keeps the users who have access to the private keys accountable, and any sensitive data remains private throughout the entire process. Therefore, the most appropriate approach is to incorporate two layers of encryption.

Additionally, in an embodiment, it is helpful that two unique users create these layers of encryption, one user for each layer. If a single user creates the two layers of encryption, it obtains access to the private key for both layers of encryption. This result is the equivalent to having a single layer of encryption. Since the user has access to the private key for both layers of encryption, this gives the user the ability to decrypt the twice encrypted message. To address this issue, one user creates a single layer of encryption, and a different user creates the second layer of encryption to maintain the integrity of the method.

Furthermore, any user within the network of users may perform the encrypted computations. For simplicity, it is determined that the user who creates the second layer of encryption performs the encrypted computation. Following the illustration of FIG. 4, the input for the first layer of encryption is a plaintext message, mₙ; this is the n-th user's position values. Using the public key for the first layer of encryption (i.e., Pk⁽¹⁾), mₙ is converted into a ciphertext, i.e., Ct⁽¹⁾ₙ. Subsequently, Ct⁽¹⁾ₙ, becomes the input to the second layer of encryption. Using the public key for the second layer of encryption (Pk⁽²⁾), each element that comprises Ct⁽¹⁾ n are encrypted, thus producing a ciphertext for each element. The outcome is a total of (K×L) ciphertexts, where (K×L) is the dimension of Ct⁽¹⁾ₙ, and K and L depend on the encrypted parameters set during the key development process.

For simplicity, let Ct⁽²⁾ₙ represent the set of ciphertext within the second layer of encryption. Traversing the opposite direction requires the appropriate private key to obtain the message or ciphertext contained in these ciphertexts. Starting with the second layer of encryption, the second layer's private key (i.e., Sk⁽²⁾) is required to decrypt the message within the ciphertexts Ct⁽²⁾ₙ. When the decryption process finishes, the decrypted result is a set of coefficients that comprises the ciphertext Ct⁽¹⁾ₙ. Then, the first layer's private key, Sk⁽²⁾, is used to decrypt Ct⁽¹⁾ₙ. After the decryption process, the decrypted result is the encrypted message. Since the n′-th user, also described herein as the assistant device, created the second layer of encryption, this may be the same user who performs the encrypted computations.

### Distribution of Keys

The encrypted proximity-based positioning method requires two users to create their own the public and private keys. The first user, the p-th user, also described herein as the user's device, or the unlocated device, is the user whose position is unknown as seen in FIG. 3. The second user, the n′-th user, also described herein as the assistant device, is part of the set of users that exist near the p-th user. The second user, the n′-th user or the assistant device or proxy thereof, may be chosen at random and n′∈N. The second user, the n′-th user or the assistant device or proxy thereof, may also be determined by the multiple anonymous other devices on the network.

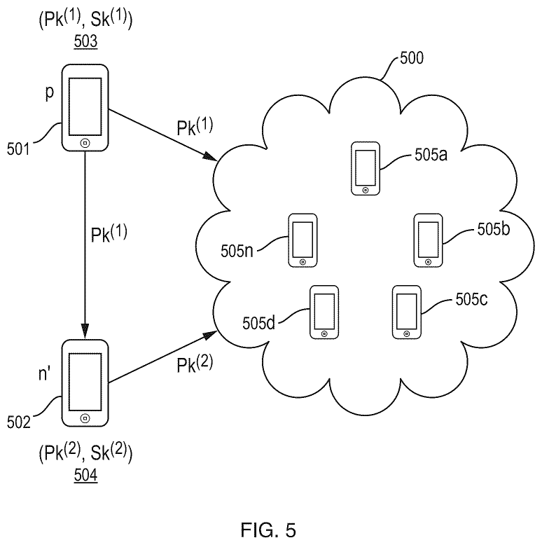

FIG. 5 is an illustration of how the public and secret keys are created and distributed throughout the network. The p-th user 501 (also described as the unlocated device, or the user device) creates the first pair of keys (Pk⁽¹⁾, Sk⁽¹⁾ 503) for the encryption, and the n′-th user 502 creates the second pair of keys (Pk⁽²⁾, Sk⁽²⁾ 504). Both users 501 and 502 distribute their public keys to all N users 505a-n, except the n′-th user 502 does not need to distribute its public key to the p-th user 501.

As seen in FIG. 5, the distribution of the keys is performed in two steps. First, the p-th user creates the first set of keys, (Pk⁽¹⁾, Sk⁽¹⁾) and the user distributes Pk⁽¹⁾ to all the users, including the n′-th user. Simultaneously, the p-th user creates the first layer of encryption. However, the p-th user retains its exclusive access to Sk⁽¹⁾. With this access, the p-th user is capable of decrypting any ciphertext within the first layer of encryption. This becomes helpful when the p-th user obtains its estimated position values, thus the p-th user must always create the first layer of encryption.

The n′-th user creates the second set of keys, (Pk⁽²⁾, Sk⁽²⁾) during the second step. The n′-th user also distributes its public key to all N users, with the possible exception of the p-th user. The n′-th user holds its access to the private key Sk⁽²⁾. Thus, the n′-th use creates the second layer of encryption and it has the capability to decrypt all the ciphertexts within the second layer of encryption.

### Encryption Process

After receiving the two public keys, (Pk⁽¹⁾, Pk⁽²⁾), each user within the network of users encrypts its position data. First, they encrypt their data using Pk⁽¹⁾, to create the first ciphertext Ct⁽¹⁾ₙ, that is:

$${Ct}_{n}^{( 1 )} = {Enc}_{{Pk}^{( 1 )}} ( {m}_{n} ) \qquad ( 10 )$$

$$n = 1 , … , N$$

Where mₙ represents the position values for the n-th user.

Each user creates this ciphertext locally and they do not transmit this ciphertext to the n′-th user. Instead, each user uses the second public key, Pk⁽²⁾ to encrypt Ct⁽¹⁾ₙ in order to create a ciphertext within the second layer of encryption, Ct⁽²⁾ₙ, as follows:

$${Ct}_{( n ; k , ℓ )}^{( 2 )} = {Enc}_{{Pk}^{( 2 )}} ( {Ct}_{n}^{( 1 )} ( k , ℓ ) ) \qquad ( 11 )$$

Where, n=1, . . . , N, k=1, . . . , K, and l=1, . . . , L.

This is equivalent to encrypting mₙ twice, once using Pk⁽¹⁾ then using Pk⁽²⁾, i.e.:

$${Ct}_{n}^{( 2 )} = {Enc}_{{Pk}^{( 2 )}} ( ( {Enc}_{{Pk}^{( 1 )}} ( {m}_{n} ) ) )$$

$$n = 1 , … , N$$

This second layer of encryption requires more than one ciphertext in order to preserve the privacy of the position data. From equation (11), a second layer of encryption requires K·L ciphertexts from a single user. This indicates that the (k^{th}, l^{th}) element of Ct⁽¹⁾ₙ needs to be encrypted using Pk⁽²⁾. After creating all the required ciphertexts within the second layer of encryption, the users transmit these ciphertexts to the n′-th user to perform the encrypted computation.

The n-user can transmit its doubled-encrypted sensitive data to the n′-th user, knowing that the n′-th user does not have access to Sk⁽¹⁾, that is required to decrypt the first layer of encryption. In the case that the p-th user intercepts Ct⁽²⁾ₙ the n-th user's data still remains private due to the fact that the p-th user does not have access to Sk⁽²⁾, that is required to decrypt the second layer of encryption. Therefore, the n-th user's sensitive data remains private at all times.

### Encryption Operations

The ciphertexts within the second layer of encryption of all the users are received by the n′-th user, i.e. {Ct⁽²⁾_{1;1:K,1:L}, . . . , Ct⁽²⁾_{N;1:K,1:L}}. In total there may be N·K·L ciphertexts received. Recall the n′ user contains the private key for the second layer of encryption, Sk⁽²⁾. This is of no use to decrypted the plaintext computation results that occurs within the second layer of encryption, because Sk⁽¹⁾ is required and only the p-th user has access to it. The n′-th user performs the required encrypted computation using all the received ciphertexts, thus specifying the second layer of encryption to be the layer of encrypted computation. Using the estimator in equation (7), the n′-th user performs the summation of all the user's encrypted data. Since each ciphertext Ct⁽¹⁾ₙ, maintains the same dimensions, the n′-th user needs to add the elements that shared the same index across all the users' ciphertext from the first layer of encryption Ct⁽¹⁾ₙ as follows:

$${Ct}_{( s , k , ℓ )}^{( 2 )} = {\sum }_{n = 1}^{N} ( {Ct}_{( n , k , ℓ )}^{( 2 )} ) \qquad ( 12 )$$

$$k = 1 , … , K$$

$$ℓ = 1 , … , L$$

Where Ct⁽²⁾_{(s,1:k,1:L)} is the encrypted computation solution to the second layer of encryption. The result of equation (12) is consistent of adding the corresponding entries for all the N first level ciphertexts, and then encrypting the result, i.e:

$$\begin{matrix}{\sum }_{n = 1}^{N} {Ct}_{( n , k = 1 , ℓ = 1 )}^{( 2 )} = {\sum }_{n = 1}^{N} {Enc}_{{Pk}^{( 2 )}} ( {Ct}_{n}^{( 1 )} ( k = 1 , ℓ = 1 ) ) \\ = {Enc}_{{Pk}^{( 2 )}} ( {\sum }_{n = 1}^{N} {Ct}_{n}^{( 1 )} ( k = 1 , ℓ = 1 ) )\end{matrix}$$

The procedure is the same for all K and L entries. In total, there is N·K·L encrypted calculations performed. If each ciphertext that forms Ct(2) s is decrypted, the result are K·L values, that forms all the elements of a first level ciphertext. Therefore, when equation (12) performs all the computations in the second layer of encryption, this becomes the equivalent of the summation all the users position values, i.e.:

$$\begin{matrix}{Ct}_{s}^{( 2 )} = {\sum }_{n = 1}^{N} {Enc}_{{Pk}^{( 2 )}} ( {Enc}_{{Pk}^{( 1 )}} ( {m}_{n} ) ) \\ = {Enc}_{{Pk}^{( 2 )}} ( {Enc}_{{Pk}^{( 1 )}} ( {\sum }_{n = 1}^{N} {m}_{n} ) )\end{matrix}$$

### Decryption Process

After performing equation (12), the results remain encrypted within the second layer of encryption. The n′-th user proceeds to decrypt the encrypted result using its private key, Sk⁽²⁾, to produce a ciphertext within the first layer of encryption, as follows:

$${Ct}_{s}^{( 1 )} ( k , ℓ ) = {Dec}_{{Sk}^{( 2 )}} ( {Ct}_{s , k , ℓ}^{( 2 )} ) \qquad ( 13 )$$

Where k=1, . . . , K, l=1, . . . , L, and Ct⁽¹⁾ is the decrypted result of the second layer of encryption. The result produces a single ciphertext acquiring the same number of entries as before and the results reflect the desired summation result:

$$\begin{matrix}{Ct}_{s}^{( 1 )} ( k = 1 , ℓ = 1 ) = {Dec}_{{Sk}^{( 2 )}} ( {Ct}_{s , k = 1 , ℓ = 1}^{( 2 )} ) \\ = {Dec}_{{Sk}^{( 2 )}} ( {Enc}_{{Pk}^{( 2 )}} ( {\sum }_{n = 1}^{N} {Ct}_{n}^{( 1 )} ( k = 1 , ℓ = 1 ) ) ) \\ = {\sum }_{n = 1}^{N} {Ct}_{n}^{( 1 )} ( k = 1 , ℓ = 1 )\end{matrix}$$

The approach above can be repeated for all the K and L entries to attest that the decrypted results in equation (13) is equivalent to summation of the corresponding entries of the non-second layer-encryption result. Additionally, equation (13) also corresponds to the n′-th user removing the second layer of encryption, i.e.:

$$\begin{matrix}{Ct}_{s}^{( 1 )} = {Dec}_{{Sk}^{( 2 )}} ( {Enc}_{{Pk}^{( 2 )}} ( {Enc}_{{Pk}^{( 1 )}} ( {\sum }_{n = 1}^{N} {m}_{n} ) ) ) \\ = {Enc}_{{Pk}^{( 1 )}} ( {\sum }_{n = 1}^{N} {m}_{n} )\end{matrix}$$

After decrypting the results and obtaining the ciphertext within the first layer of encryption, the n′-th user transmits Ct⁽¹⁾ₛ to the p-th user. The p-th user is the user who created the pair of keys for the first layer of encryption, thus indicating that the user has Sk⁽¹⁾. With this key, the p-th user is able to decrypt Ct(s.

The p-th user proceeds to decrypt the received ciphertext using its private key Sk⁽¹⁾:

$$\begin{matrix}\overline{m} = {Dec}_{{Sk}^{( 1 )}} ( {Ct}_{s}^{( 1 )} ) \\ = {Dec}_{{Sk}^{( 1 )}} ( {Enc}_{{Pk}^{( 1 )}} ( {\sum }_{n = 1}^{N} {m}_{n} ) ) = {\sum }_{n = 1}^{N} {m}_{n}\end{matrix} \qquad ( 14 )$$

The result from equation (14), is the summation of position for all the users in the network. Now, the p-th user can obtain its estimated position values using equation (14) and given that number of users in the network are known, i.e.:

$${m}_{p} \text{?} = \frac{1}{N} \overline{m} \qquad ( 15 )$$

$$\text{?} \text{indicates text missing or illegible when filed}$$

Throughout the entire process, the sensitive data sent by all N users remained private. Due to the ability to have the data encrypted twice by using different public keys, this prevented the n′-th user to obtain the computational result after it performed the operations. As mentioned before, the n′-th user is not required to compute the encrypted computation. Any user within the network of users or even the p-th user may perform these computations, but the encrypted result in the second layer of encryption must always be returned to the n′-th user. This is due to the n′-th user having access to Sk⁽²⁾. The analysis of the encrypted proximity-based positioning method is able to produce the estimator seen in equation (7), where the noise variance is constant for all users and mₙ ≃mₚ as Δₙ→0 for n=1, . . . , N. Furthermore, this shows that compared to the estimator in equation (6), the unweighted proximity-based estimator is a more realistic estimator, since equation (6) assumes that the n-th user knows its distance from the p-th user. This cannot be the case, since at all times, the p-th user and the n-th user positions are kept private from each other. Additionally, the importance of computation complexity is noted. The estimator seen in equation (5) requires multiple multiplication operations. Within the FHE domain, this drastically increases the space overhead and the computation complexity.

Therefore, in the environment of the encrypted proximity-based positioning method, the estimator that requires the least amount of computational operations would reduce the amount of space and time that a user needs to make the calculations, thus making equation (7) the ideal estimator, according to an embodiment.

### Results

The results are divided into two parts. The first analyzes the proximity-based position estimator, while the second set of experiments aim at analyzing the proximity-based encrypted positioning solution.

### Proximity-Based Estimator

To analyze the three different estimators, seen in equation (5), equation (6), and equation (7), a simulator was created that generator random data (position coordinates) around a stationary position. The data was generated according to:

$${y}_{n} \sim ( {m}_{p} + {Δ}_{n} , {σ}_{n}^{2} I ) \qquad ( 16 )$$

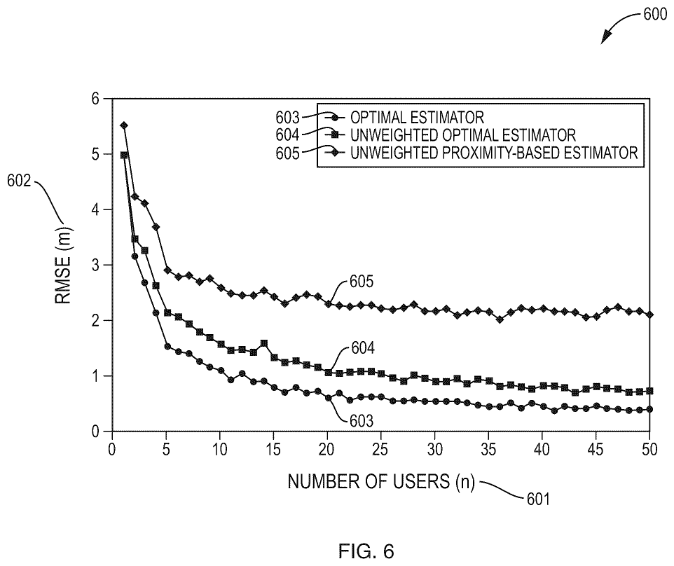

The mean of the distribution consisted of the “true” or stationary position of the p-th user and the deterministic distance between the p-th user and the n-th user. This deterministic distance is represented by Δₙ. Furthermore, the variance value for each user was different, thus σ²ₙ₋₁≠σ²ₙ. The boundary set for the proximity-based positioning method was set to ϵ=40 (m), as seen in equation (1). Any user outside this boundary was not considered to be part of the network of users. Each estimator was evaluated using different numbers of observations performed by a certain set of users. For example, when the simulator set five users to be present, it collected a single sample and determined the root means squared error (RMSE), then a second time the simulator would observe two samples for the same five users and then determine the RMSE. The maximum number of observations record for a certain set of users was 100 measurement values and there were at most 50 users present. A summary of the RMSE values are given in FIG. 6.

FIG. 6 shows a plot 600 illustrating the relationship between the number of users (n) 601 versus the RMSE value (m) 602. Plot 600 illustrates three different estimators, the optimal estimator 603, the unweighted optimal estimator 604, and the unweighted proximity-based estimator 605.

From the results given in FIG. 6, it is clear that the optimal estimator seen in equation (5) performed the best compared to the other two estimators. This estimator did not make many assumptions from the sample random generator, it had the information of the true distance between the p-th user and the n-th user. This means that the estimator did not consider Δₙ to be zero. Furthermore, it also had acknowledged of true values of each random sample.

The next best estimator is the estimator seen in equation (6), also seen in FIG. 6 as the unweighted optimal estimator. Just like the optimal estimator, the unweighted optimal estimator had knowledge of the distance between the p-th user and the nth user, meaning Δₙ₋₁≠Δₙ. With this information, the estimator was able to minimize the impact from users that were further away from the p-user. The difference seen the between the unweighted optimal estimator and the optimal estimator is established through the knowledge of the variance of the measurement uncertainty. Since the unweighted optimal estimator had zero knowledge of the variance, it assumed that every n-th user measurement uncertainty variance is the same. The unweighted proximity-based estimator had the most restrictive assumptions; every n-th user's variance is the same and they share the same position as the p-th user. Based on the results in FIG. 6, these estimators improves as more users are within the network.

### Encryption Parameters

Based on the results described above, the unweighted proximity-based estimator was analyzed to implement with the fully homomorphic encryption, using the Pyfhel library [13], Different encryption parameters were tested, mainly the polynomial degree value n. This parameter was shown to be crucial for this solution because of its influence in the computational and storage cost. As shown previously, the polynomial degree is a factor on the modulus value for the ciphertext modulus value and it had the requirement that the polynomial degree needs to be a value that is a power of 2. The higher the polynomial degree, the more the ciphertext modulus domain grower. Similarly, this was the same situation for the plaintext modulus value. The case when the polynomial degree value was set to 1024 was tested first. This value was set to both layers of encryption. Because of the limitation this value was not successful with the second layer of encryption. This second layer of encryption required a higher plaintext modulus because of the ciphertext coefficient values were high and the amount of computation seen during the computation process was excessive for the domain.

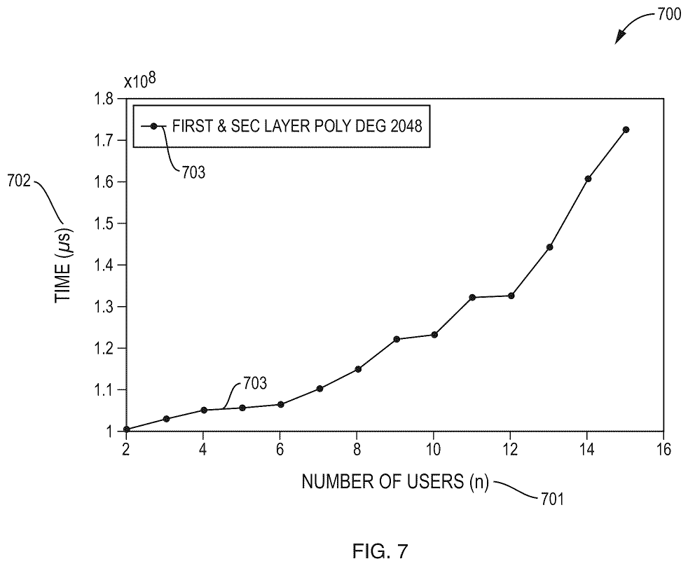

FIG. 7 shows a plot 700 illustrating the relationship between the number of users (n) 701 versus time (ρs) 702 using the polynomial degree 2048 703.

Second, the polynomial degree to 2048 was set. These results are seen in FIG. 7. Based on these results, the number of users that participate within the solution may increase the computational complexity. As seen earlier, an estimator may improve accuracy with more users or target devices engage in the network, but it may hinder performance when addressing the privacy concern issue. Therefore, increasing the accuracy increases the computational cost. The third polynomial degree tested was 4096. At this value, the ciphertexts grew exponentially, and it required a large amount of memory storage. It can be argued that this may become ideal to improve accuracy, but it also increases the computational cost.

### CONCLUSION

Embodiments described herein is the use of proximity-based for range-free positioning of devices. In particular, the contribution of this work presents a novel method that enables such positioning in a privacy-preserving manner such that collaborative agents in the network do not reveal their position in the process. The described framework uses fully homomorphic encryption methodology, where certain operations can be performed on encrypted data. A multilayer encryption method was introduced to implement the privacy-preserving proximity-based position method system that achieves the objective of preserving position information of agents to be revealed. Two layers are identified that provide the sufficient about of privacy required and it keeps every participate accountable in the duration of time. Based on the results, the described method is ideally used with a polynomial degree small enough that provides the privacy for the users.

### REFERENCES

[1] A. Acar, H. Aksu, A. S. Uluagac, and M. Conti. A survey on homomorphic encryption schemes: Theory and implementation. ACM Computing Surveys (CSUR), 51(4):1-35, 2018.
[2] M. G. Amin, P. Closas, A. Broumandan, and J. L. Volakis. Vulnerabilities, threats, and authentication in satellite-based navigation systems[scanning the issue]. Proceedings of the IEEE, 104(6):1169-1173, 2016.
[3] V. Bianchi, P. Ciampolini, and I. De Munari. Rssi-based indoor localization and identification for zigbee wireless sensor networks in smart homes. IEEE Transactions on Instrumentation and Measurement, 68(2):566-575, 2018.
[4] D. Dardari, P. Closas, and P. M. Djuri'c. Indoor tracking: Theory, methods, and technologies. IEEE Transactions on Vehicular Technology, 64(4):1263-1278, 2015.
[5] P. Davidson and R. Pich'e. A survey of selected indoor positioning methods for smartphones. IEEE Communications Surveys & Tutorials, 19(2):1347-1370, 2016.
[6] J. Fan and F. Vercauteren. Somewhat practical fully homomorphic encryption. Cryptology ePrint Archive, 2012.
[7] R. Faragher and R. Harle. Location fingerprinting with bluetooth low energy beacons. IEEE journal on Selected Areas in Communications, 33(11):2418-2428, 2015.
[8] M. Fazio, A. Buzachis, A. Galletta, A. Celesti, and M. Villari. A proximity-based indoor navigation system tackling the covid-19 social distancing measures. In 2020 IEEE Symposium on Computers and Communications (ISCC), pages 1-6. IEEE, 2020.
[9] C. Gentry. Fully homomorphic encryption using ideal lattices. In Proceedings of the forty-first annual ACM symposium on Theory of computing, pages 169-178, 2009.
[10] C. Gentry, A. Sahai, and B. Waters. Homomorphic encryption from learning with errors: Conceptually-simpler, asymptotically-faster, attribute-based. In Annual Cryptology Conference, pages 75-92. Springer, 2013.
[11] S. He and S.-H. G. Chan. Wi-fi fingerprint-based indoor positioning: Recent advances and comparisons. IEEE Communications Surveys & Tutorials, 18(1):466-490, 2015.
[12] G. Hernandez, G. LaMountain, and P. Closas. Privacy-preserving cooperative positioning. In Proceedings of the 33rd International Technical Meeting of the Satellite Division of The Institute of Navigation (ION GNSS+2020), pages 2667-2675, 2020.
[13] A. Ibarrondo and A. Viand. Pyfhel: Python for homomorphic encryption libraries. In Proceedings of the 9th on Workshop on Encrypted Computing & Applied Homomorphic Cryptography, pages 11-16, 2021.
[14] C. Laoudias, A. Moreira, S. Kim, S. Lee, L. Wirola, and C. Fischione. A survey of enabling technologies for network localization, tracking, and navigation. IEEE Communications Surveys & Tutorials, 20(4):3607-3644, 2018.
[15] A. Mackey, P. Spachos, L. Song, and K. N. Plataniotis. Improving ble beacon proximity estimation accuracy through bayesian filtering. IEEE Internet of Things Journal, 7(4):3160-3169, 2020.
[16] Y. J. Morton, F. van Diggelen, J. J. Spilker Jr, B. W. Parkinson, S. Lo, and G. Gao. Position, Navigation, and Timing Technologies in the 21st Century: Integrated Satellite Navigation, Sensor Systems, and Civil Applications. John Wiley & Sons, 2021.
[17] A. Narayanan, N. Thiagarajan, M. Lakhani, M. Hamburg, D. Boneh, et al. Location privacy via private proximity testing. In NDSS, volume 11, 2011.
[18] E. Novak and Q. Li. Near-pri: Private, proximity based location sharing. In IEEE INFOCOM 2014-IEEE Conference on Computer Communications, pages 37-45. IEEE, 2014.
[19] X. Peng, R. Chen, K. Yu, F. Ye, and W. Xue. An improved weighted k-nearest neighbor algorithm for indoor localization. Electronics, 9(12):2117, 2020.
[20] S. Shiraki and S. Shioda. Contact information-based indoor pedestrian localization using bluetooth low energy beacons. IEEE Access, 10:119863-119874, 2022.
[21] S. Subedi, H.-S. Gang, N. Y. Ko, S.-S. Hwang, and J.-Y. Pyun. Improving indoor fingerprinting positioning with affinity propagation clustering and weighted centroid fingerprint. IEEE Access, 7:31738-31750, 2019.
[22] M. Van Dijk, C. Gentry, S. Halevi, and V. Vaikuntanathan. Fully homomorphic encryption over the integers. In Annual International Conference on the Theory and Applications of Cryptographic Techniques, pages 24-43. Springer, 2010.
[23] B. Wang, Q. Chen, L. T. Yang, and H.-C. Chao. Indoor smartphone localization via fingerprint crowdsourcing: Challenges and approaches. IEEE Wireless Communications, 23(3):82-89, 2016.
[24] S. Xu, R. Chen, Y. Yu, G. Guo, and L. Huang. Locating smartphones indoors using built-in sensors and wi-fi ranging with an enhanced particle filter. IEEE Access, 7:95140-95153, 2019.
[25] R. K. Yadav, B. Bhattarai, H.-S. Gang, and J.-Y. Pyun. Trusted k nearest bayesian estimation for indoor positioning system. IEEE Access, 7:51484-51498, 2019.
[26] F. Yin, Y. Zhao, and F. Gunnarsson. Proximity report triggering threshold optimization for network-based indoor positioning. In 2015 18th International Conference on Information Fusion (Fusion), pages 1061-1069. IEEE, 2015.
[27] Y. Yu, R. Chen, L. Chen, X. Zheng, D. Wu, W. Li, and Y. Wu. A novel 3-d indoor localization algorithm based on ble and multiple sensors. IEEE Internet of Things Journal, 8(11):9359-9372, 2021.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer implemented method for determining a geospatial location of an unlocated device communicatively coupled to a network, the method comprising:
activating a transmission of a first encryption layer public key associated with a first encryption layer, the transmission performed by the unlocated device, or proxy thereof, to enable multiple anonymous other devices communicatively coupled to the network, including an assistant device, to employ the first encryption layer public key; and
decrypting, at the first encryption layer, by the unlocated device, or proxy thereof, a first layer encrypted anonymized solution to a mathematical function performed by the assistant device, or proxy thereof, on representations of the geospatial locations of the multiple anonymous other devices at a first encryption layer, the decrypting performed by using a first encryption layer secret key associated with the first encryption layer public key, the decrypting producing a decrypted solution employed by the unlocated device as a representation of the geospatial location of the unlocated device.

2. The computer implemented method of claim 1, further comprising:
activating a transmission of, by the assistant device, or proxy thereof, a second encryption layer public key to the multiple anonymous other devices in the network in a manner that causes the multiple anonymous other devices to return to the assistant device, or proxy thereof, respective representations of geospatial locations encrypted first by the first encryption layer public key and second by the second encryption layer public key;
decrypting, at the second encryption layer, by the assistant device, or proxy thereof, the second layer encrypted representations of the geospatial locations of the multiple anonymous other devices by using a second encryption layer secret key associated with the second encryption layer public key to produce first layer encrypted representations of the geospatial locations of the multiple anonymous other devices; and
performing a mathematical function on the first layer encrypted representations of the geospatial locations of the multiple anonymous other devices, by the assistant device, or proxy thereof, to produce the first layer encrypted anonymized solution to the mathematical function at the first encryption layer.

3. The computer implemented method of claim 1, further comprising, by the unlocated device, encrypting a location request message at the first encryption layer, the location request message at the first encryption layer being able to be decrypted by the use of the first encryption layer secret key.

4. The computer implemented method of claim 3, further comprising, by the assistant device, encrypting a response to the location request message by the multiple anonymous other devices at the second encryption layer, the response to the location request message at the second encryption layer being able to be decrypted by the use of a second encryption layer secret key.

5. The computer implemented method of claim 1, further comprising, by the unlocated device, encrypting at the first encryption layer or, by the assistant device, at the second encryption layer a location request message, or a response to a location request message by the multiple anonymous other devices at the second encryption layer using an encryption method that has an ability to perform an unlimited number of addition and multiplication operations on a ciphertext.

6. The computer implemented method of claim 1, further comprising: (i) encrypting a location request message to ciphertext using the first encryption layer public key, the second encryption layer public key, or a combination thereof, and (ii) decrypting the ciphertext using the first encryption layer secret key, the second encryption layer secret key, or a combination thereof.

7. The computer implemented method of claim 1, further comprising:
performing, by the assistant device, an averaging function of anonymized responses to a location request message received by the multiple anonymous other devices; and
the unlocated device decrypting a response to a location request message containing the encrypted anonymized solution to the mathematical function, the solution being the average of the representations of the geospatial locations of the multiple anonymous other devices.

8. The computer implemented method of claim 1, further comprising selecting the multiple anonymous other devices from a plurality of devices based on an indication of a distance from the unlocated device, the indication being a function of a response time to a broadcast signal initiated by the unlocated device, the assistant device, or a combination thereof.

9. The computer implemented method of claim 8, further comprising:
enabling the multiple anonymous other devices to provide, representations of respective geospatial locations at the first encryption layer by using a first encryption layer public key, and at a second encryption layer, by using the second encryption layer public key; and
causing at least one of the multiple anonymous other devices in a fixed location to provide a representation of a geospatial location.

10. The computer implemented method of claim 9, wherein the network has a perimeter defined by perimeter devices of the multiple other devices defining a network boundary, and further comprising analyzing multiple consecutive decrypted anonymized solutions to the mathematical function to determine that the unlocated device is within the perimeter of the network boundary.

11. The computer implemented method of claim 1, further comprising:
choosing, by the unlocated device, at least one assistant device from the multiple devices; or
determining, amongst the candidate assistant devices, which of the multiple anonymous other devices will serve as the assistant device.

12. The computer implemented method of claim 1, wherein at least one assistant device performs the averaging of the respective representations of geospatial locations of the multiple anonymous other devices.

13. The computer implemented method of claim 1, wherein the use of the first encryption layer and second encryption layer, and sequence of use thereof, preserves private information, identity, and geospatial location of the multiple anonymous other devices in the network.

14. The computer implemented method of claim 1, wherein the network is a non-satellite based geospatial location network, and wherein the unlocated device self-identifies a loss of, or an uncertainty of, satellite-based geospatial location information, and activates a secondary non-satellite based geolocating method, the secondary geolocating method performs the transmitting and the decrypting to determine the geospatial location of the unlocated device.

15. The computer implemented method of claim 1, further comprising, estimating, by each of the multiple anonymous other devices, a respective position value accuracy by using any one of an optimal estimator, an unweighted optimal estimator, or an unweighted proximity-based estimator.

16. The computer implemented method of claim 1, wherein the transmitting the first encryption layer public key is transmitted to a repository or server, wherein the multiple anonymous other devices are communicatively coupled to the repository or server, and the multiple anonymous other devices transmit their representations of geospatial location to the repository or server to be retrieved by the unlocated device.

17. A non-transitory computer readable medium configured to store thereon program instructions which, when loaded and executed by a processor, cause the processor to:
activate a transmission of a first encryption layer public key associated with a first encryption layer, the transmission performed by the unlocated device, or proxy thereof, to enable multiple anonymous other devices communicatively coupled to the network, including an assistant device, to employ the first encryption layer public key; and
decrypt, at the first encryption layer, by the unlocated device, or proxy thereof, an encrypted anonymized solution to a mathematical function performed and encrypted by the assistant device, or proxy thereof, on representations of the geospatial locations of the multiple anonymous other devices at a second encryption layer, the decrypting performed by using: (i) a second encryption layer public key, and (ii) a first encryption layer secret key associated with the first encryption layer public key, the decrypting producing a decrypted solution employed by the unlocated device as a representation of the geospatial location of the unlocated device.

18. The non-transitory computer readable medium of claim 17, further comprising program instructions which, when loaded and executed by a processor, cause the processor to:
activate a transmission of, by the assistant device, or proxy thereof, a second encryption layer public key to the multiple anonymous other devices in the network in a manner that causes the multiple anonymous other devices to return to the assistant device, or proxy thereof, respective representations of geospatial locations encrypted first by the first encryption layer public key and second by the second encryption layer public key;
decrypt, at the second encryption layer, by the assistant device, or proxy thereof, the encrypted representations of the geospatial locations of the multiple anonymous other devices by using the second encryption layer public key and a second encryption layer secret key associated with the second encryption layer public key; and
perform a mathematical function on the decrypted representations of the geospatial locations of the multiple anonymous other devices, by the assistant device, or proxy thereof, to produce the encrypted anonymized solution to the mathematical function at the first encryption layer.

19. The non-transitory computer readable medium of claim 17, further configured:
by the unlocated device, to:
encrypt a location request message at the first encryption layer, the location request message at the first encryption layer being able to be decrypted by the use of the first encryption layer secret key; and
by the assistant device, to:
to encrypt a response to the location request message by the multiple anonymous other devices at the second encryption layer, the response to the location request message at the second encryption layer being able to be decrypted by the use of a second encryption layer secret key.

20. The non-transitory computer readable medium of claim 17, further configured, by the unlocated device, to encrypt at the first encryption layer or, by the assistant device, at the second encryption layer a location request message, or a response to a location request message by the multiple anonymous other devices at the second encryption layer using an encryption method that has an ability to perform an unlimited number of addition and multiplication operations on a ciphertext.
